(19) United States
(12) Patent Application Publication
(10) Pub. No.: US 2017/0053478 A1
(43) Pub. Date: Feb. 23, 2017

(54) ILLUMINATED BEZEL FOR A GAMING MACHINE

(71) Applicant: BALLY GAMING, INC., Las Vegas, NV (US)

(72) Inventors: KARL E. WUDTKE, HENDERSON, NV (US); MICHAEL D. OWENS, RENO, NV (US); VERNON BERNARD, LAS VEGAS, NV (US)

(21) Appl. No.: 14/831,197

(22) Filed: Aug. 20, 2015

(51) Int. Cl. G07F 17/32; G07F 17/34

(52) U.S. Cl. CPC G07F 17/3213; G07F 17/34

(57) ABSTRACT

A gaming system includes an outcome display device and a reel bezel assembly. The reel bezel assembly includes a bezel encompassing the outcome display device. The bezel includes a light pipe that extends between a proximal end and a distal end of the bezel, where the proximal end is closer to a player position in front of the gaming machine and the distal end is immediately adjacent to the outcome display device. A light source emits light directed at the proximal end of the bezel that propagates through the light pipe and illuminates the bezel. The bezel is made from a light-transmissive material and has a front surface facing the player position and a reflective rear surface. The bezel may also include light windows in the rear surface allowing one or more light sources to provide light emitted directly onto the outcome display device transversely through the bezel.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to a translucent illuminated bezel of a display device.

### BACKGROUND OF THE INVENTION

Commercial gaming equipment with a display device typically utilize a bezel surrounding the display device (mechanical reels, spinning wheel elements, liquid crystal display panel, plasma display panel, etc.). Among the many types and varieties of bezels, most bezels are black and plain, and are not particularly noteworthy to observe. Bezels of this type are not variable in display or design, and cannot be easily modified in accordance with game events, content display, or themed environments. Rather than installing a typical “square, black box” to cover the display device, a bezel that is aesthetically pleasing to look at is desired. Further, the ability to dynamically light and decorate a bezel surrounding a display device of gaming equipment increase the aesthetic value of the gaming equipment and impacts the player experience.

Display devices for gaming equipment may also implement bezels to reduce (or provide) contrast with the displayed content of the display device. External lighting of the bezel may also occur to enhance or camouflage the edges of the display device, the bezel itself, and/or gaps between the bezel and the display device. Lighting of this type is limited to light sources that provide light to an isolated specific region of the bezel or surrounding area. A highly desirable feature for modern gaming equipment would include a bezel acting as a fully self-contained lighting system, incorporating computer controlled lighting elements to dynamically decorate the bezel from within.

### SUMMARY OF THE INVENTION

According to one aspect of the present invention, a gaming machine includes an outcome display device and a reel bezel assembly. The reel bezel assembly includes a bezel encompassing the outcome display device and a light source. The bezel forms a light pipe extending between proximal and distal ends of the bezel. The proximal end of the bezel is closer to a player position in front of the gaming machine than the distal end of the bezel. The distal end of the bezel is immediately adjacent to the outcome display device. The light source is arranged to emit light directed at the proximal end of the bezel such that the light passes through the light pipe and illuminates the bezel.

According to one aspect of the present invention, a gaming machine includes an outcome display device and a reel bezel assembly. The reel bezel assembly comprises a bezel and a light source. The bezel encompasses the outcome display device. The bezel has a light-diffusing front surface, a reflective back surface, and a curved cross-sectional shape sloping away from a player position in front of the gaming machine toward the outcome display device. The front surface of the bezel is visible from the player position. The bezel forms a light pipe extending between proximal and distal ends of the bezel, the proximal end being closer to the player position than the distal end. The distal end of the bezel is immediately adjacent to the outcome display device. The light source is arranged to emit light directed at the proximal end of the bezel such that the light passes through the light pipe and illuminates the bezel.

According to another aspect of the invention, a regulated gaming machine primarily dedicated to playing at least one casino wagering game is disclosed. The gaming machine includes an outcome display device and a reel bezel assembly. The reel bezel assembly comprises a bezel encompassing the outcome display device and one or more light sources. The bezel forms a light pipe extending between proximal and distal ends of the bezel. The proximal end of the bezel is closer to a player position in front of the gaming machine than the distal end of the bezel. The distal end of the bezel is immediately adjacent to the outcome display device. The one or more light sources are adjacent to the proximal end of the bezel and are arranged to emit light directed at the proximal end of the bezel such that the light passes through the light pipe and illuminates the bezel.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4A is a perspective view of a reel bezel assembly according to an embodiment of the present invention.

FIG. 4B is a perspective view of a reel bezel assembly encompassing a set of mechanical reels according to an embodiment of the present invention.

FIG. 5 is a section view of the reel bezel assembly in FIG. 4B as viewed along line 5-5, according to an embodiment of the present invention.

FIG. 6A is a section view of the reel bezel assembly in FIG. 5 as viewed along line 6A-6A, according to an embodiment of the present invention.

FIGS. 6B-6C are different perspectives of the section view of the reel bezel assembly in FIG. 6A, according to an embodiment of the present invention.

FIG. 7 is a perspective view of a reel bezel having reel-lighting windows, according to an embodiment of the present invention.

FIG. 8A is a section view of the reel bezel assembly in FIG. 7 as viewed along line 8A-8A, further configured with a light board and light directing cup, according to an embodiment of the present invention.

FIG. 8B is a different perspective of the section view of the reel bezel assembly in FIG. 8A, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

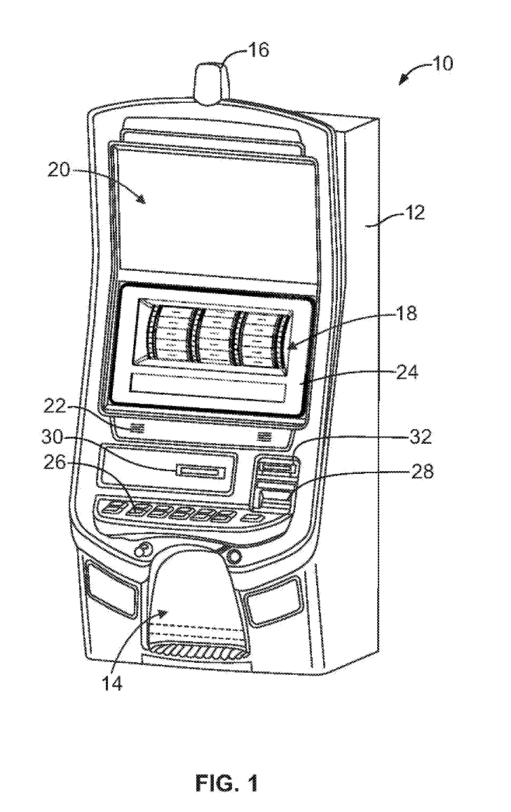

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bar top models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. A mechanical-reel display device acts as an outcome display device when one or more outcomes for one or more games are conducted. For aesthetic purposes, a bezel may encompass the outcome display device having a proximal end (proximal to a player position in front of the gaming machine) and a distal end immediately adjacent to the outcome display device. The bezel may be illuminated by one or more light sources adjacent or proximate to the bezel.

The gaming machine 10 may include a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

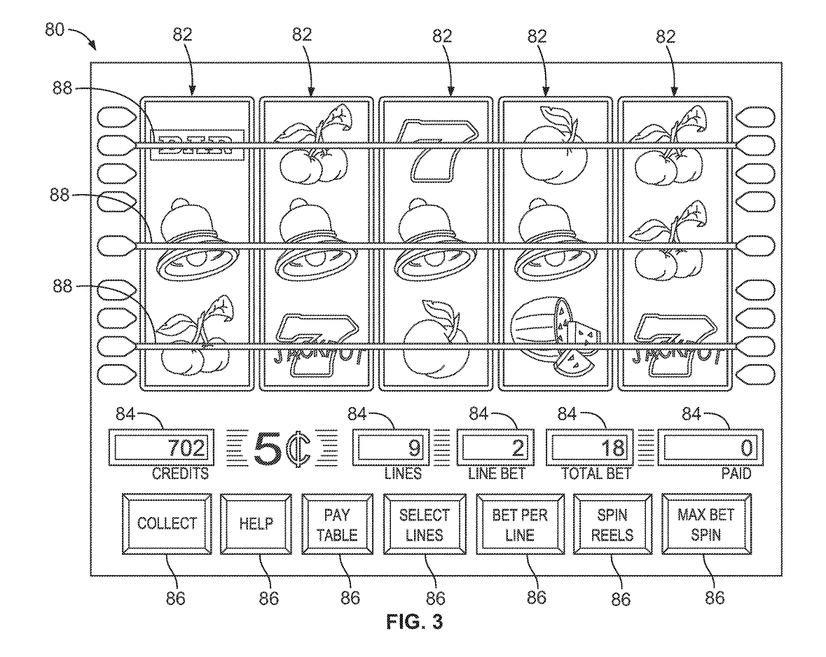

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cash out input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

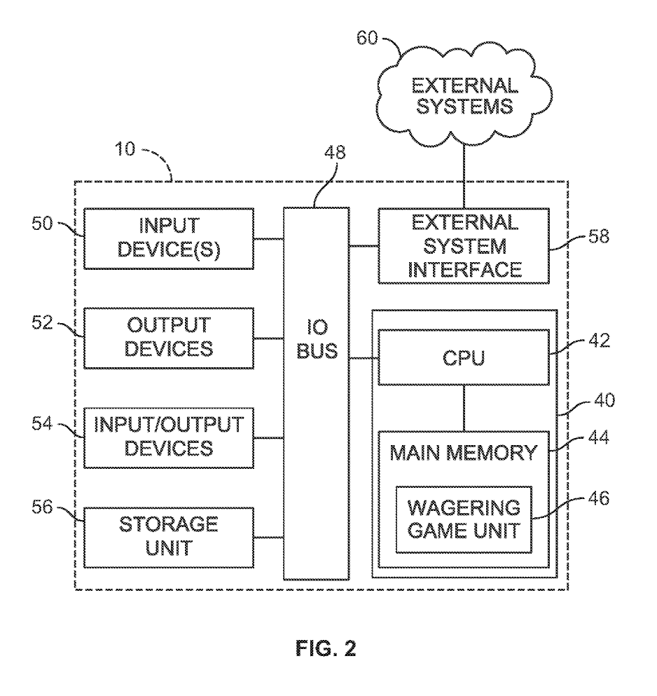

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part, that accompany or overlay a set of mechanical symbol-bearing reels acting as an output display device.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RING), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

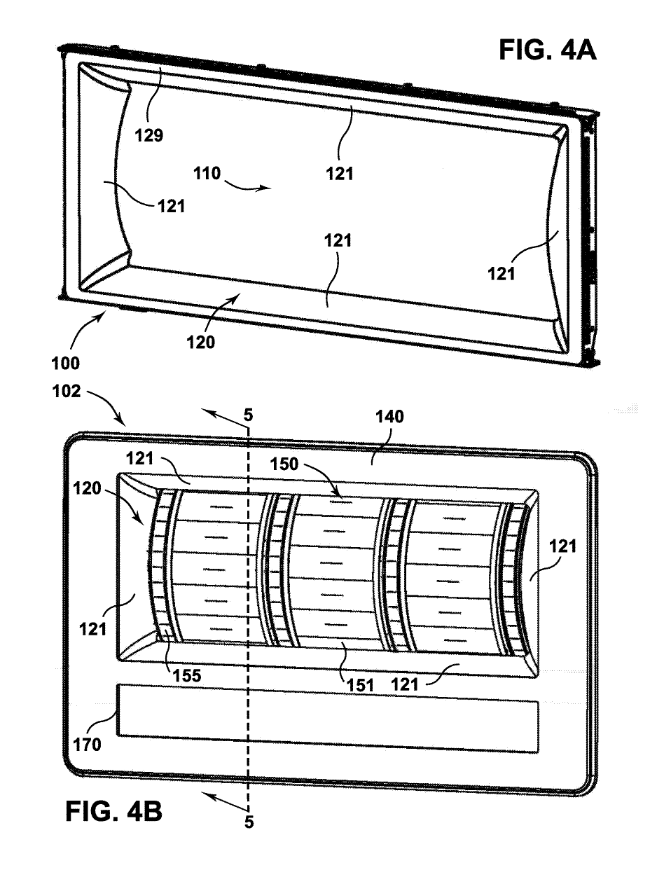

Referring now to FIG. 4A, a perspective view of a reel bezel assembly 100 is shown in one embodiment. The bezel assembly 100 includes an opening 110 that accommodates an outcome display device (not shown). The bezel assembly 100 includes a bezel 120 having front faces 121 observable from a player position (e.g., in front of the gaming machine). The faces 121 are illuminated when light is directed at a proximal end of the bezel 120, enters the bezel 120 at the proximal end, propagates through the bezel 120 (directly and via internal reflection), and exits the bezel 120 via one or more of the faces 121. The bezel 120 may also include a flat frontal portion 129 that may or may not be visible, may or may not be illuminated by light sources, and may or may not be positioned or mounted adjacent or proximate to an overlying display device (e.g., display 18, 20), a touchscreen (e.g., touchscreen 24), a glass or plastic display device shield, or any combination of these. The flat portion 129 may include holes to accommodate one or more fasteners for mounting the flat portion 129 flush against of the bezel assembly 100 to a cabinet, housing, or display device shield.

Referring now to FIG. 4B, a perspective view of a reel bezel assembly 102 is shown in one embodiment. The bezel assembly 102 includes a bezel 120 encompassing an outcome display device 150. An outcome display device 150 may be a wide variety of game outcome displaying equipment, including mechanical reels (as shown), a computerized display monitor (e.g., liquid crystal display (LCD), light-emitting diode (LED), or plasma display panel), a rotating wheel, or essentially any other type of hardware configured to display a visual gaming outcome performed by the gaming equipment. The bezel 120 is abutted against a flat front panel 140. The flat panel 140 may be a modular front face of the bezel 120 or the bezel 120 may be mounted to the panel 140 such that any internal components are shielded from view in addition to protecting underlying screen or touchscreen components. Generally, the bezel 120 has a curved cross-sectional shape sloping toward the outcome display device 150 from the proximal end to the distal end. The bezel 120 is constructed from a light-transmissive material that may be additionally light-diffusing. In various embodiments, the bezel 120 diffuses light propagating throughout to one or more front faces 121 visible from the player position.

In one embodiment, the panel 140 may be the primary display device 18 or touchscreen 24 of gaming machine 10. In other embodiments, the bezel 120 and panel 140 encompass the primary display device 18. Further, the panel 140 (and additionally the bezel 120) may include a secondary viewing window 170 allowing additional effects to be displayed therein. For example, the window 170 may reveal an internal lighting component, an additional display device, or another display component that may be part of, or separate from, the outcome display device 150. For example, window 170 may allow one or more display components of the gaming machine to display computer controlled diffused lighting and patterns (e.g., via a light-transmissive material), graphical imagery or animation (e.g., via a light-emitting diode or an organic light-emitting diode display), computer-generated graphics representing a meter (e.g., increasing bar graph reflecting a percentage of a given threshold or timer), a multiple meter user interface, a visual deck of virtual buttons for player selection, static or scrolling textual messages, etc.

In one embodiment, the outcome display device 150 comprises a plurality of mechanical reels 151 and a plurality of pay line indicators 155. The pay line indicators 155 are positioned on each side of each mechanical reel 151 such that internal lighted elements may be used to illuminate sections highlighting and specifying combinations of symbols displayed on various sections of the reels 151. Likewise, the reels 151 may include interior lighting elements illuminating displayed symbols, separately or in combination with the payline indicators 155.

The faces 121 of the bezel 120, the reels 151, the pay line indicators 155, and the window 170 are configured to be observable by the player positioned at a player position in front of the gaming machine. The player (and observers) proximate to the player position may be presented with various types of coordinated lighting patterns of the various components. Additionally, each distinct component (e.g., the bezel 120 and faces 121) may include coordination of multiple lighting elements that distinguish, highlight, and/or decorate specific regions of the component separately or in combination with other regions.

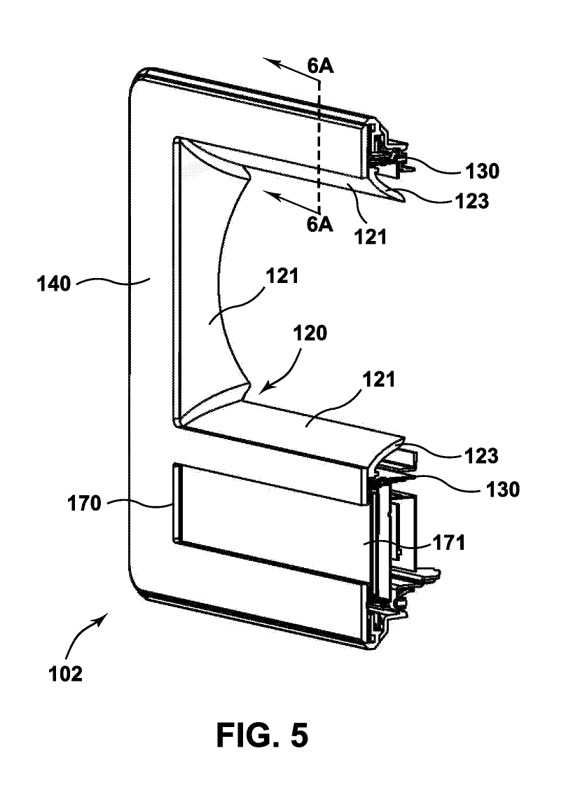

Referring now to FIG. 5, a section view of the reel bezel assembly 102 as viewed along line 5-5 in FIG. 4B is shown in one embodiment. The bezel assembly 102 includes a light board 130 adjacent to a proximal end of the bezel at each of the faces 121. The light emitting from the light sources on the light board 130 is directed at the proximal end of the bezel and propagates through the light pipe 123 portion of the bezel 120 prior to being emitted by the faces 121. The light pipe 123 enables light to internally reflect within the light-transmissive material of the bezel 120 and diffuse at the surface to illuminate the bezel face 121.

The light board 130 enables sections of the bezel 102 to be dynamically lit using individually controlled red-green-blue light-emitting diodes (LEDs) mounted thereon to create a variety of colors and animated effects on the bezel 120 during operation. A reflective backing on the light pipe 123 blocks all light from passing through, forcing all the LED light within the light pipe 123 to emit from the bezel face 121. Each side of the bezel 120 has an associated light board 130. Each light board 130 houses a set of individually controllable LED lighting elements that emit light into proximate regions of the bezel 120 via the light pipe 123 to illuminate each side of the bezel 120.

A window 170 reveals one or more display components 171 positioned within the reel bezel assembly 102. The display components 171 may include additional lighting elements, one or more display devices, or a combination of these, as discussed prior.

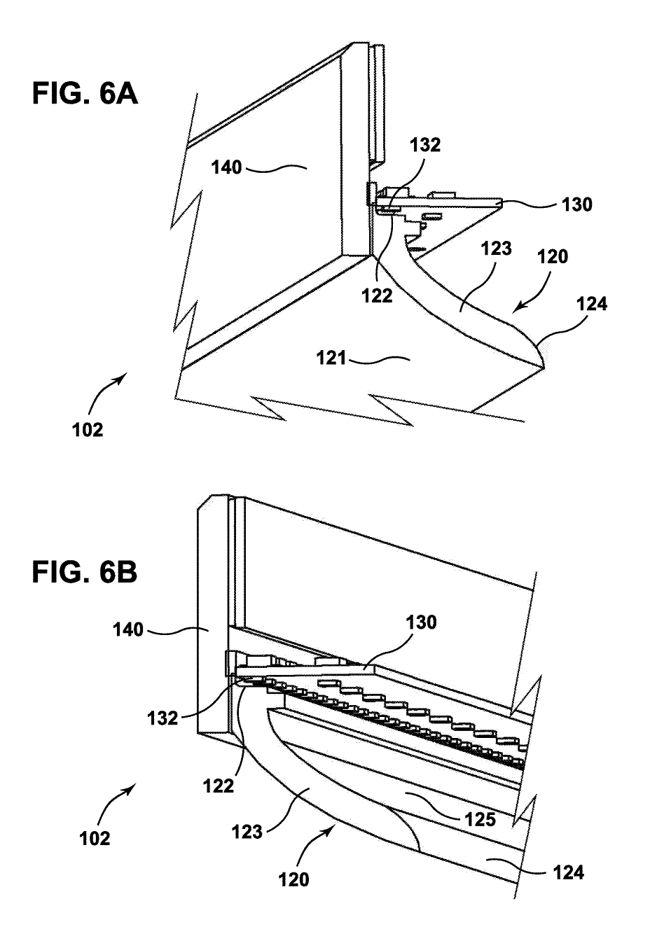

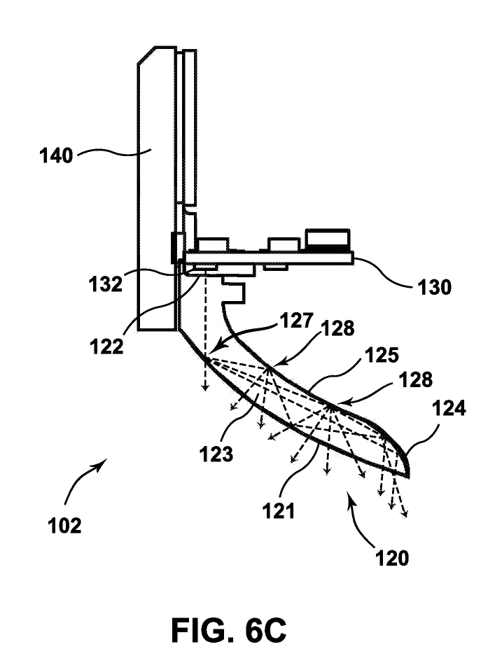

Referring now to FIG. 6A, a section view of the reel bezel assembly 102 as viewed along line 6A-6A in FIG. 5 is shown in one embodiment. The bezel 120 has a light pipe section 123 having a proximal end 122 and a distal end 124. The proximal end 122 of the light pipe 123 receives light from an immediately adjacent light source 132 positioned on light board 130. The panel 140 shields the light board 130, the lighting component(s) 131, and the proximal end 122 from view from the player position in front of the gaming machine. Light received at the proximal end 122 passes through the light pipe 123 and illuminates the bezel by diffusing and emitting from the bezel face 121. The face 121 of the bezel may be textured to improve the diffusion of light as it emits from the light-diffusive material.

Referring now to FIG. 6B, a different perspective view of the section view of the reel bezel assembly 102 in FIG. 6A is shown in one embodiment. In this perspective, a rear face 125 of the bezel 120 is shown. The bezel 120 is designed to distribute light from the light sources 132 within the bezel 120 to be illuminated by the front faces 121. Thus, the rear face 125 is coated with a reflective treatment (e.g., paint) to inhibit light from exiting the light pipe 123 via this surface. The rear face 125 may also be physically textured (or chemically treated) to improve diffusion of light inside the light pipe 123 and at the surface of the faces 121 upon re-emission. Thus, the rear face 125 may be light-diffusive in addition to being light-reflective. Other areas of the light pipe 123 and bezel 120 may be similarly coated, treated, physically etched, or otherwise fabricated to impart light diffusion and reflection in a variety of ways as light enters and/or exits the bezel 120.

Additionally, the distal end 124 may be rounded to maintain or enhance internal reflection of light at this edge, keeping more light in the light pipe 123 for increased illumination of one or more regions of the bezel 120. The distal end 124 may be additionally treated or textured identically to the rear face 125 to maximize reflection and diffusion of light. Various treatments and texturing of the surfaces of the bezel 120 (e.g., the front face 121, the proximal end 122, the distal end 124, and/or the rear face 125) alter the lighting effects observed on the face 121 of the bezel, and may be varied while remaining within the intended scope and spirit of the invention. Alternatively, the distal end 124 may be cut flat causing the flat edge to illuminate and project light toward a reflector or diffuser to be directly visible from the player position.

Referring now to FIG. 6C, another perspective view of the reel bezel assembly 102 in FIG. 6A is shown in one embodiment. The light source 132 mounted on the light board 130 emits light directed at the proximal end 122 of the bezel 120. As the light from the light source 132 (shown by dashed arrows) enters the light pipe 123, it strikes the inside surface of the front face 121 at point 127. A portion of the light is emitted by the face 121 of the bezel 120. The remainder of the light internally reflects, staying within the light-transmissive material of the light pipe 123. The diffusive nature of the face 121 may cause diffusion of the light inside the light pipe 123, in addition to the light reflection. Some of the reflected light strikes the rear face 125 of the bezel 120 at points 128 where the light is reflected and diffused.

Additionally, light passing through the light pipe 123 via front face 121 may be diffused upon exit. Thus, each single arrow shown passing through the front face 121 represents only a single light ray passing straight through the face 121. However, many diffused light rays may be emitted at the surface of the face 121 due to the diffusive nature of the material and/or coatings.

In one embodiment, the rear face 125 is treated with a reflective treatment coating and reflects essentially all light that strikes it. In addition to the reflective treatment(s), the rear face 125 is likewise textured to increase light diffusion upon reflection. Thus, all light striking the rear face 125 is both diffused and reflected creating a more uniform distribution of light within the light pipe 123. The curved nature of the distal end 124 also diffuses and internally reflects light to the front face 121, even when no treatments are applied thereto. The combined diffusion and reflection of light from the distal end 124 and the rear face 125 results in an enhanced distribution of light emitted from the front face 121 of the bezel 120.

In one embodiment, the light board 130 includes a plurality of evenly-spaced light-emitting diodes (LEDs). In other embodiments, various spacing and clustering of lighting components may be used to create different lighting effects on one or more faces 121 of the bezel 120 during operation. The computer-controlled illumination of the light sources 132 on the light board 130 enables a wide variety of illumination effects to be carried out on the bezel 120, directly observable from the player position at the front of the gaming machine.

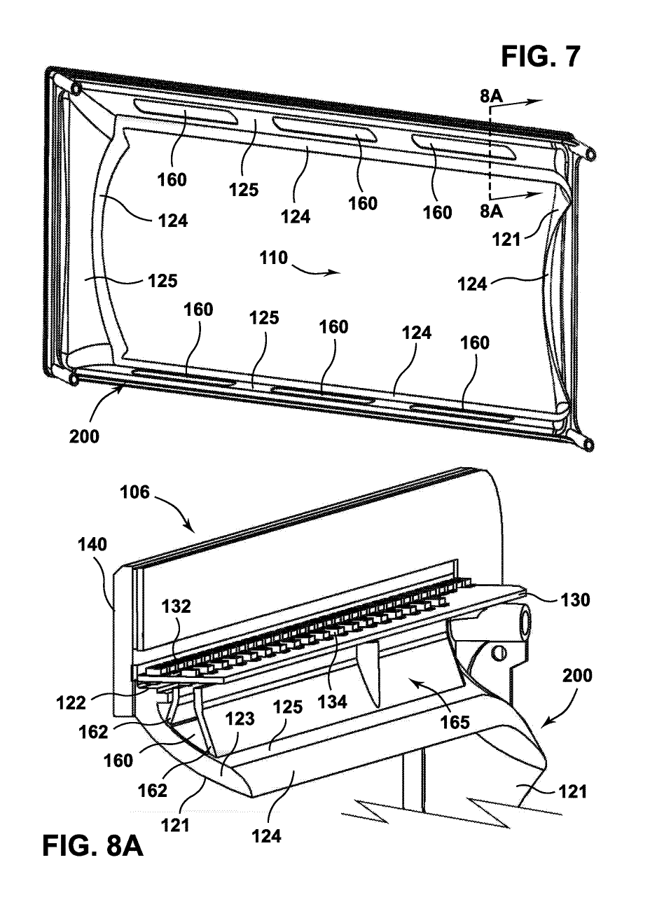

Referring now to FIG. 7, a perspective view of the back side of a bezel 200 having reel-lighting and highlighting windows is shown in one embodiment. The bezel 200 may be part of a reel bezel assembly that includes other components (e.g., multiple light boards with lighting elements, a protective cover 140, etc.) The bezel 200 includes an opening 110 that accommodates an outcome display device (not shown). The bezel 200 is structurally similar to the bezel assembly 100 (FIG. 4A), having an additional set of non-reflective light windows 160, exposed on the rear face 125, that inhibit reflection and diffusion of light. In one embodiment, the rear face 125 reflects and diffuses light, but the smooth and clear nature of the windows 160 provide a way for light to travel directly through the bezel from the rear face 125 to be emitted by the front face 121 directly. Thus, light emitting from the front face 121 at the regions corresponding to the windows 160 may be used to directly illuminate the outcome display device (e.g., reels 151). The light windows 160 may be chemically treated differently from the rear face 125 to reduce or entirely eliminate reflection and diffusion, or require a physical treatment that removes, alters, or replaces the coatings or treatments performed for the remainder of the rear face 125.

The bezel 200 may have a single unified window 160 spanning the entire length of the bezel face 121 and is not limited to the specific shape, number, and design of the windows 160 shown in FIG. 7. Further, windows 160 may be implemented on all sides of the bezel 200, for example, by masking the reflective coating on the rear face 125 in specific regions all around the perimeter of the bezel 200. The curved shape of the bezel 200 causes light contained within to be guided and internally reflect, rather than exit the bezel 200 through the window(s) 160.

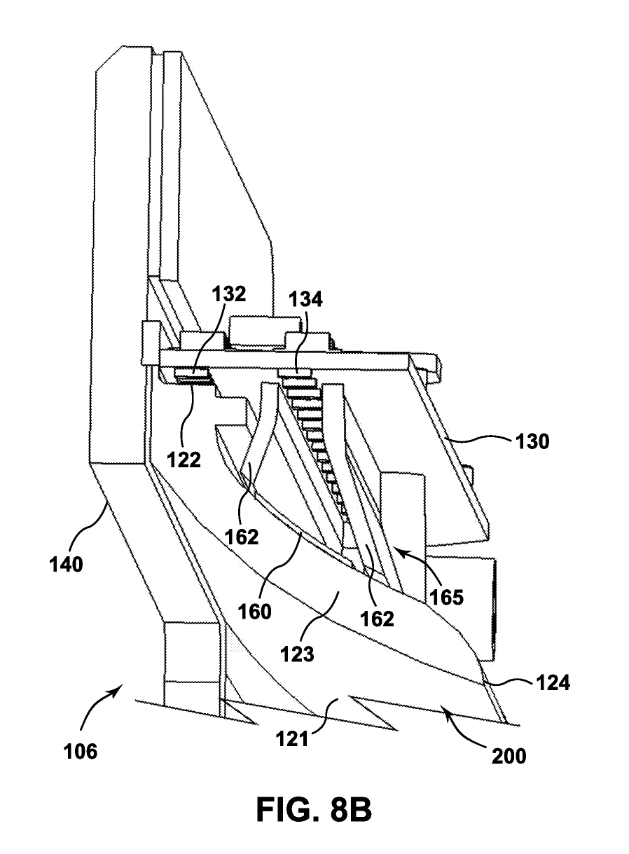

Referring now to FIG. 8A, a section view of the reel bezel assembly in FIG. 7 as viewed along line 8A-8A, further configured with a light board and light directing cup, is shown in one embodiment. FIG. 8B is another perspective of the section view of the reel bezel assembly in FIG. 8A. The bezel assembly 106 includes the bezel 200, a light board 130, a flat panel cover 140, and a light cup 165. The bezel 200 includes elongated light windows 160 as detailed above. The cover 140 shields the edges of the bezel 200 and the internal components of the reel bezel assembly 106 from view and potential tampering.

The light board 130 (light source) is configured with a first row of lighting components 132 and a second row of lighting components 134. The first row of lighting components 132 are aligned with the proximal end 122 to emit light such that light propagates through the light pipe 123 to the front face 121, the distal end 124, and the rear face 125. The second row of lighting components 134 is aligned to emit light directly to the window 160 via the light cup 165. Thus, the light from the second row of lighting components 134 passes through the window 160 and the bezel 200 to illuminate the reels and be observed at a player position in the front of the gaming machine.

The light cup 165 comprises two light shields 162 that are aligned along the length of the window 160 to maximize the amount of light from the second row of lighting components 134 reaching the window 160. In short, the light cup 165 aligns and directs the light from the second row of lighting components 134 prior to entering the bezel via the window 160. The light shields 162 are reflective, for example, mirror-like, formed from white or light-colored plastic, or a result of one or more treatments to various materials. The light cup 165 directs light from the second row of lighting components 134 of the light board 130 to the window 160. The light cup may also shield the light from the first row of lighting components 132 from shining directly on the window 160. In other embodiments, light presented at the window 160 at the rear face 125 of the bezel 200 may originate from the first row of lighting components 132 or from another light source entirely (e.g., mounted internally in the gaming machine).

In one embodiment, when the windows 160 as shown in FIG. 7 are integrated into the bezel assembly 102 of FIG. 4B, the upper and lower faces 121 of the bezel 120 display a bar of solid light illuminating each of the symbol-bearing reels 151. During operation, the right and left front faces 121 of the reel 200 appear similarly to the right and left front faces 121 of the bezel 120 of the reel bezel assembly 102.

The light from the first row of lighting components 132 travels through the bezel 200 transversely to the light from the second row of lighting components 134. Also, the light passing through the one or more windows 160 of the bezel 200 does not significantly interfere with the light propagating through the light pipe 123. Further, the light cups 165 may be shaped to fit windows 160 of virtually any shape and size, and any number of windows 160 may be present on the rear face 125 of the bezel 200. Altering the reflective and/or light-diffusive properties of the bezel 200 may be used to change the way light emits from the front faces 121. The placement, orientation, and shape of the windows 160 and lighting components 134 provide effective ways to control the lighting of the bezel 200.

The windows 160 may also be a result of shapes, patterns, or lighting achieved by the use of surface etching (e.g., of one or both of front face 121 and/or rear face 125), attached decals, applied paint, LED positioning, etc. For example, the use of back lighting and light cups 162 to achieve a visually enhanced effect including symbols, lines, dots, etc., on a face 121 can be achieved by omitting the reflective treatment in sections of the rear face 125.

The use of separate light cups 162 can be used to shine light (at one or multiple angles) through defined window sections to create light designs observable on the bezel 200 from the player position. Designs may also be imparted directly on a front face 121 to provide differentiate light projected at the surface of the face 121. For example, an additional frosted-treatment layer that mirrors or resembles a projected design can be placed on the front surface to provide enhanced depth to the lighting effect.

Designs and symbols etched into the window 160 and/or bezel 200 may also glow when edge lit. It is possible to stack several layers of clear acrylic, having something etched on each layer, to create a design visible on the final bezel 200. Further, by edge lighting each layer of the bezel 200 separately, the different symbols can be made to glow independently from each other.

One or more additional light pipes may be implemented that provides directed light at the rear face 125 such that light is directed through (or otherwise emits from) the window 160 of the rear face 125. Additional light pipes, lighting channels, light cups, etc., may be achieved using components in conjunction with a single light board 130, with or without additional light boards having additional lighting components, including LEDs.

The use of a bezel 200 of this type is not limited to symbol-bearing reels of the type displayed by the reels 151. Other types of bezels may include wheel shrouds, topper crowns, seat back enhancements, computer or display monitor bezels, LCD button displays, etc.

The invention may also be practiced on bezels that do not conform to the same four-sided structure shown in the figures. For example, a rounded bezel may have one or several faces exposed to a player position that emit light propagated via a light pipe bezel, as described. By using a light source supplying light to a proximal end of a light pipe extending to a distal end of the light pipe, thereby illuminating the bezel, the invention provides a configuration and method for greatly improving the aesthetics of the periphery of a display device.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A reel bezel assembly for a gaming machine, the gaming machine including an outcome display device, the assembly comprising:
a bezel encompassing the outcome display device, the bezel forming a light pipe extending between proximal and distal ends of the bezel, the proximal end being closer to a player position in front of the gaming machine than the distal end, the distal end being immediately adjacent to the outcome display device; and
a light source arranged to emit light directed at the proximal end of the bezel such that the light passes through the light pipe and illuminates the bezel.

2. The reel bezel assembly of claim 1, wherein the outcome display device includes a plurality of symbol-bearing reels.

3. The reel bezel assembly of claim 1, wherein the light source includes a plurality of light-emitting diodes.

4. The reel bezel assembly of claim 1, wherein the bezel has a curved cross-sectional shape that slopes toward the outcome display device from the proximal end to the distal end.

5. The reel bezel assembly of claim 1, wherein the bezel includes a light-diffusing front surface and a reflective back surface, the front surface visible from the player position.

6. The reel bezel assembly of claim 5, wherein the reflective back surface diffuses reflected light.

7. The reel bezel assembly of claim 5, wherein the reflective back surface includes an elongated non-reflective window, and further including a second light source emitting second light transversely through the bezel via the non-reflective window directly onto the outcome display device.

8. The reel bezel assembly of claim 7, further including a light cup configured to align and direct the second light to enter the bezel via the non-reflective window.

9. A reel bezel assembly for a gaming machine, the gaming machine including an outcome display device, the assembly comprising:
a bezel encompassing the outcome display device, the bezel having a light-diffusing front surface, a reflective back surface, and a curved cross-sectional shape sloping away from a player position in front of the gaming machine toward the outcome display device, the front surface visible from the player position, the bezel forming a light pipe extending between proximal and distal ends of the bezel, the proximal end being closer to the player position than the distal end, the distal end being immediately adjacent to the outcome display device; and
a light source arranged to emit light directed at the proximal end of the bezel such that the light passes through the light pipe and illuminates the bezel.

10. The reel bezel assembly of claim 9, wherein the outcome display device includes a plurality of symbol-bearing mechanical reels.

11. The reel bezel assembly of claim 9, wherein the light source includes a plurality of light-emitting diodes positioned around a perimeter of the bezel.

12. The reel bezel assembly of claim 9, wherein the reflective back surface is textured to diffuse reflected light.

13. The reel bezel assembly of claim 9, wherein the reflective back surface includes an elongated non-reflective window, and further including a second light source emitting second light transversely through the bezel, via the non-reflective window and a corresponding window on the front surface, directly onto the outcome display device.

14. The reel bezel assembly of claim 13, further including one or more light shields configured to align and direct the second light to enter the bezel through the non-reflective window and the corresponding window.

15. A regulated gaming machine primarily dedicated to playing at least one casino wagering game, comprising:
an outcome display device; and
a reel bezel assembly comprising:
a bezel encompassing the outcome display device, the bezel forming a light pipe extending between proximal and distal ends of the bezel, the proximal end being closer to a player position in front of the gaming machine than the distal end, the distal end being immediately adjacent to the outcome display device; and
one or more light sources adjacent to the proximal end of the bezel, the one or more light sources arranged to emit light directed at the proximal end of the bezel such that the light passes through the light pipe and illuminates the bezel.

16. The gaming machine of claim 15, wherein the light source includes a plurality of light-emitting diodes.

17. The gaming machine of claim 15, wherein the bezel has a curved cross-sectional shape that slopes toward the outcome display device from the proximal end to the distal end

18. The gaming machine of claim 15, wherein the bezel includes a light-diffusing front surface and a reflective back surface, the front surface visible from the player position.

19. The gaming machine of claim 18, wherein the reflective back surface includes an elongated non-reflective window, and further including a second light source emitting second light transversely through the bezel via the non-reflective window directly onto the outcome display device.

20. The gaming machine of claim 19, further including a light cup configured to align and direct the second light to enter the bezel via the non-reflective window.
